(19) United States
(12) Patent Application Publication
(10) Pub. No.: US 2004/0182706 A1
(43) Pub. Date: Sep. 23, 2004

(54) Microinjection method and device based on electroosmosis

(76) Inventor: Leyi Li, Memphis, TN (US)

Correspondence Address: Leyi Li, 6556 Patmore Road, Memphis, TN, 38134, US

(21) Appl. No.: 10/657,055

(22) Filed: Sep. 8, 2003

Related U.S. Application Data
(60) Provisional application No. 60/455,957, filed on Mar. 20, 2003.

(51) Int. Cl. G01N 27/453

(52) U.S. Cl. 204/451; 204/601

(57) ABSTRACT

A method and device is provided for the microinjection of materials into a cell by using electroosmosis. The invention integrates an electric circuit into a conventional microinjection device and uses an electroosmotic force to propel the flow of fluid inside the injection capillary. The device comprises an electric power supply, output cables, capillary-holding devices, removable electrodes, holding capillary and injection capillary. During microinjection an electric current is delivered to the capillary-holding device from the power supply. The electric current is further directed to the fluid inside the injection capillary through the removable electrodes. The electric current produces an electroosmotic force inside the injection capillary to propel the flow of the fluid inside the injection capillary during microinjection. The fluid flow stops immediately once the electric current is turned off. This invention provides a revolutionary mechanism for the control of the fluid flow during microinjection.

### CROSS REFERENCE TO RELATED APPLICATIONS

This application claims the benefit of the U.S. Provisional Application No. 60/455,957, filed on Mar. 20, 2003, which is incorporated herein by reference.

### FIELD OF THE INVENTION

The present invention relates to injection of materials into eggs or embryos to create transgenic animals. More particularly, it details a microinjection method and device utilizing electroosmosis as a driving force to propel the flow of fluid inside a micro capillary during microinjection.

### BACKGROUND OF THE INVENTION

Transgenic technology has become a powerful platform for biomedical research, drug discovery and production of bio-therapeutic agents. Transgenic animals are created by the introduction and integration into an individual of genes from another species or breed. Four major methods have been used to deliver gene constructs into cells, and they are membrane fusion and uptake method, electroporation or electro-permeabilization method, bombardment method and microinjection method. The fusion and uptake method uses substances such as liposome to encapsulate DNA and then transfer the DNA into a cell through fusion with the cell membrane. It allows for the treatment of large numbers of cells at one time. It is simple but its efficiency is very low. The electroporation or electro-permeabilization method utilizes the fact that materials can diffuse into a cell through tiny pores formed on the cell membrane under the influence of an electric field (Chang D C, Chassy B M, Saunders J A, Sowers A E, Guide to electroporation and electrofusion, Academic Press, San Diego, Calif., 1992; Tsong T Y. Electroporation of cell membranes. Biophys J. 1991 August;60(2):297-306; Glaser R W, Leikin S L, Chernomordik L V, Pastushenko V F, Sokirko A I. Reversible electrical breakdown of lipid bilayers: formation and evolution of pores. Biochim Biophys Acta. 1988 May 24;940(2):275-287). The pores will re-seal once the electric field disappears. Under some instances, the electric field can be even localized to a portion of a cell to induce a local permeabilization of the cell membrane. Materials can then enter the cell by diffusion. Owen and Piotrowski first used the method of localized electro-permeabilization of a cell in 1987 in a patch-clamp setting (Owen D G, Piotrowski M R C. Electropermeabilization of single cells under patch clamp. J. Physiol. 1987;390, 14P). This method was further defined (Ryttsen F, Farre C, Brennan C, Weber S G, Nolkrantz K, Jardemark K, Chiu D T, Orwar O. Characterization of single-cell electroporation by using patch-clamp and fluorescence microscopy. Biophys J. 2000 October;79(4):1993-2001; Nolkrantz K, Farre C, Brederlau A, Karlsson R I, Brennan C, Eriksson P S, Weber S G, Sandberg M, Orwar O. Electroporation of single cells and tissues with an electrolyte-filled capillary. Anal Chem. 2001 Sep. 15;73(18):4469-4477; Olofsson J, Nolkrantz K, Ryttsen F, Lambie B A, Weber S G, Orwar O. Single-cell electroporation. Curr Opin Biotechnol. 2003 February; 14(1):2934), and a patent was granted on this method in 2003 (U.S. Pat. No. 6,521,430). Bombardment method usually coats DNA onto tiny particles and then projects the particles towards cells at such a speed that the particles will penetrate into the cells. The DNA is then released into the cells. Microinjection, on the other hand, mechanically penetrates a cell with a micro capillary and directly delivers DNA into the cell. It is a tedious but the most efficient and widely used method in creating transgenic animals (Hogan B, Beddington R, Costantini F, and Lacy E, Manipulating the Mouse Embryo. New York: CSHL Press, 1994).

A typical setup for microinjection is illustrated in FIG. 1 and it includes micro-syringe 1 to produce negative or positive hydraulic pressure, capillary-holding device 2 to hold the holding capillary 3 or the injection capillary 4, micromanipulator 5 to position the holding capillary 3 or the injection capillary 4, and a microscope 6 to observe the microinjection process. The capillary-holding device 2 is placed on the micromanipulator 5. Hydraulic pressure is often transmitted by plastic pressure tubing from the micro-syringe 1 to the capillary-holding device 2, and then to the holding capillary 3 or the injection capillary 4 to control the flow of fluid inside the capillaries.

It is often difficult to control the fluid flow inside the injection capillary 4 during microinjection in this hydraulic microinjection device. Fluid flow inside the injection capillary 4 is induced by a hydraulic pressure produced by the micro-syringe 1. Due to the extremely small size (0.1 to 1.mu.m) at the tip of the injection capillary 4, a high hydraulic pressure is usually required to force fluid to flow out of the injection capillary 4. High hydraulic pressure takes time to build up and to come down, making it difficult to precisely control the flow of the fluid inside the injection capillary 4 during microinjection. Very often fluid is still leaking out of the injection capillary 4 when the capillary is being withdrawn from the egg. The leak of fluid during the capillary withdrawal will prevent the cell membrane from resealing and subsequently result in the lysis of the egg after the injection. Therefore, a better control of the fluid flow is needed to improve the efficiency and egg survival during microinjection.

We have found that electroosmosis can be used to propel the flow of fluid inside the injection capillary during microinjection and it provides a much better control of the fluid flow than hydraulic pressure. Electroosmosis is the process of inducing a fluid flow adjacent to a stationary charged surface under an external electric field (Dan Harris, Quantitative Chemical Analysis, W H Freeman, NY, 1999). When silica, which is often used as the injection capillary during microinjection, is in contact with an aqueous solution, its surface hydrolyzes to form negatively charged silanol groups depending on the pH of the solution. At a pH around 7.4, the pH of most DNA injection solutions, the surface groups will mainly hydrolyze to form SiO^{—}. The negatively charged SiO^{—} groups on the inner surface of a silica capillary will attract positively charged ions and repel negatively charged ions in the solution, causing a build-up of positive charges near the inner surface. Under an external electric field the concentration of positive charges at the surface creates a mass movement of the positively charged ions towards the cathode. The mass movement drags the whole solution and even the neutral species with it to create an electroosmotic flow. Electroosmosis has been known for quite a long time but only recently it has become very popular in the field of micro fluidic systems and capillary electrophoresis. Although almost all the research and application of electroosmosis have been focused on microfluidic systems, microchips and capillary electrophoresis, we have found that it can be used to facilitate the control of fluid flow during microinjection. Here we describe a microinjection method and device based on the principle of electroosmosis.

### BRIEF SUMMARY OF THE INVENTION

It is the primary object of the present invention to provide a microinjection method with a better control of fluid flow during microinjection. It is another principal object of the invention to provide a microinjection device based on electroosmosis.

The present invention integrates an electric circuit into a conventional microinjection device to propel the flow of fluid inside the injection capillary by electroosmosis. To this end, an electric current is provided to the liquid inside the injection capillary. The electric current creates an electroosmotic force to propel the flow of the liquid inside the injection capillary. Microinjection is conducted essentially the same way as in a conventional hydraulic microinjection. An egg is grabbed and held by a holding capillary while the injection capillary is pushed into the egg by manipulating the micromanipulators. Once the injection capillary is positioned inside the egg, an electric current is delivered to the injection capillary to force liquid to flow out of the injection capillary by means of electroosmosis. Once enough liquid is delivered into the egg, the electric current is switched off and the injection capillary is withdrawn.

The invention has the following advantages comparing to a conventional hydraulic microinjection device: easy and precise control of fluid flow during microinjection, consistent performance, less damages to the egg, higher egg survival after injection and more transgenic founders.

### BRIEF DESCRIPTION OF THE DRAWING

FIG. 1 is a diagrammatical illustration of a conventional hydraulic microinjection setup.

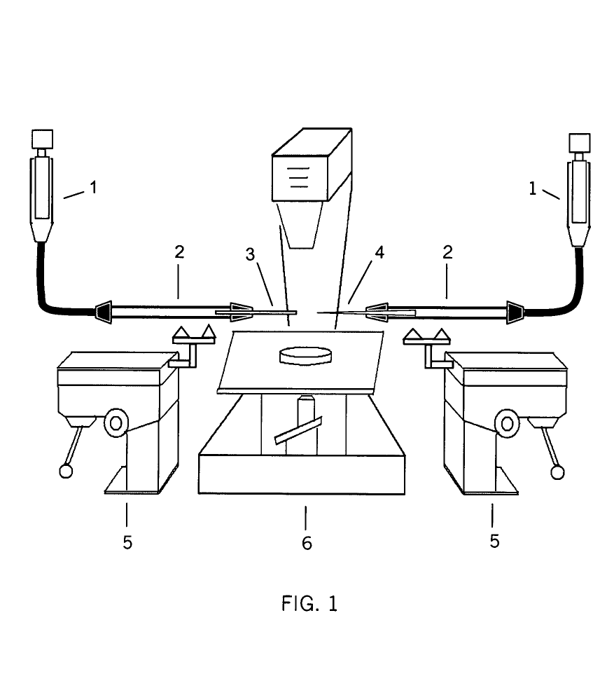

FIG. 2 is a diagrammatical illustration of an embodiment of the electroosmosisbased microinjection method in accordance with the present invention.

FIG. 3 is a diagrammatical illustration of an embodiment of the removable electrode assembled with an injection capillary and a capillary-holding device in accordance with the present invention.

### DETAILED DESCRIPTION OF THE INVENTION

As used herein the term “egg” includes oocyte, zygote, embryo and embryonic cell. The term “medium” includes any solution used for holding, handling and culturing eggs. The term “micro-syringe” includes any device that can be used to regulate hydraulic pressure.

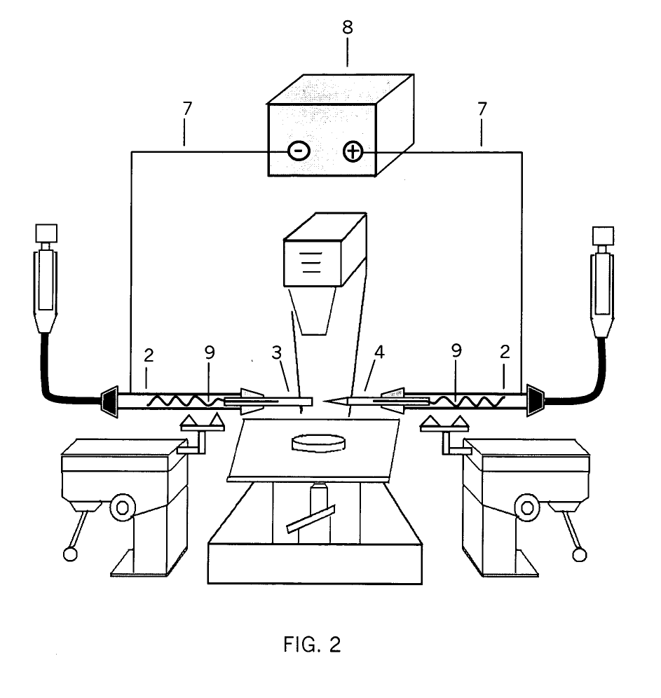

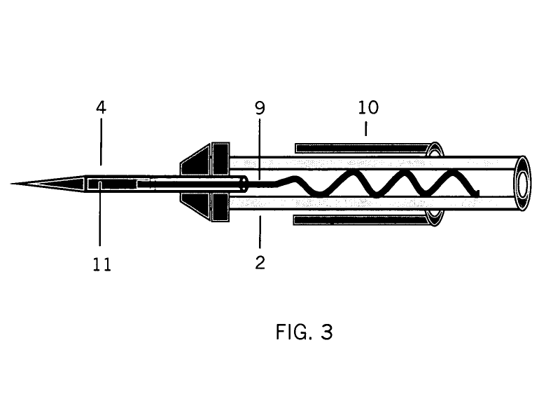

The present invention adds an electric current to the injection capillary of a microinjection setup to initiate and to control the flow of fluid inside the injection capillary during microinjection. Referring to FIG. 2, the preferred embodiment of the present invention includes a power supply 8, output cable 7, capillary-holding device 2, removable electrode 9, holding capillary 3 and injection capillary 4. Comparing to a conventional hydraulic microinjection device, the present invention has added the electric power supply 8, output cable 7 and the removable electrode 9. During microinjection a short pulse of electric current is delivered to the injection capillary 4 to induce an electroosmotic flow in the injection capillary. The electric current is first directed to the capillary-holding devices 2 from the electric power supply 8 through the output cable 7. Referring to FIG. 3, the electric current is further directed to the fluid 11 inside the injection capillary 4 by the removable electrode 9. One end of the removable electrode 9 is immersed in the fluid 11 inside the injection capillary 4 while the other end makes contact with the inner surface of the capillary-holding device 2, allowing electric current to pass from the capillary-holding device 2 to the fluid 11. Another removable electrode is also placed inside the holding capillary and its capillary-holding device the same way as in the injection capillary. Referring to FIG. 2, during microinjection, the electric current starts from the anode of the power supply 8, passes through the output cable 7, capillary-holding device 2, removable electrode 9 inside the injection capillary 4, fluid inside the injection capillary 4, the egg, the fluid inside the holding capillary 3, the removable electrode 9 inside the holding capillary 3, the other capillary-holding device 2, the other output cable 7, and finally reaches the cathode of the power supply 8. The electric current creates an electric field inside the injection capillary 4 and produces an electroosmotic force to propel the fluid to flow out of the injection capillary. The speed of the electroosmotic flow is positively related to the strength of the electric field. The stronger the electric field, the faster the electroosmotic flow. The electroosmotic flow stops immediately once the electric field disappears. The control of the fluid flow in this invention is made as instant as the turning on/off of the electric current. This invention provides a revolutionary new mechanism to propel the flow of fluid inside the injection capillary during microinjection.

The power supply in this invention can be direct current (DC). In one embodiment, the power supply is a low-voltage DC power supply. A fluid flow comparable to a hydraulic microinjection device can be achieved at about 12V DC in this invention. Although higher voltage can produce stronger electroosmotic flow, the use of voltage higher than 30V is not encouraged because it is often unnecessary and it also poses a potential hazard to personnel. In another embodiment, the power supply has a voltage control knob to adjust the output voltage. In another embodiment, the output of the electric current is controlled by a foot switch during microinjection. A timer can be also used to control the duration of the output of the electric current. A low-voltage DC power supply can be obtained commercially or manufactured easily by those skilled in the art.

Referring to FIG. 3, the removable electrode 9 is to transmit the electric current from the capillary-holding device 2 to the fluid 11 inside the injection capillary 4. To this end, the removable electrode 9 should be made of a conductive material. The removable electrode 9 is inserted into the injection capillary 4 on one end, and on the other end it makes stable contact with the inner surface of the capillary-holding device 2. In one embodiment, the removable electrode 9 is a piece of metal wire of 8 cm long and 28 AWG (AWG=American Wire Gauge) in diameter. Preferably it is made of silver. The removable electrode 9 is straight on one end but has one or more curved shapes on the other end, which are easy to make for those skilled in the art. Preferably the size of the curved shapes is larger than the inside diameter of the capillary-holding device 2. When inserted into the capillary-holding device 2 the curved shapes are bent to fit to the size of the lumen of the capillary-holding device 2, therefore forcing the curved shapes of the removable electrode 9 to make contact with the inner surface of the capillary-holding device 2.

The removable electrode can be easily removed and replaced because it is not physically fixed to the capillary-holding device. Capillary-holding devices with a fixed electrode inside are commercially available. Some of the examples are pipette holders from Warner Instruments, Hamden, Conn. (www.warneronline.com) or from Harvard Apparatus Company, Holliston, Mass. (www.harvardapparatus.com). The electrode is either physically embedded in the body of those commercially available capillary-holding devices or the electrode is fixed to the body by a washer and a screw, making the removal of the electrode difficult or impossible. Those capillary-holding devices with a fixed electrode are not suitable for DNA microinjection. During microinjection DNA fragments can stick to the electrode. If the same electrode is used for the injection of another DNA solution, the previous DNA fragments will contaminate the new DNA solution. DNA cross-contamination during microinjection is unacceptable in the production of transgenic animals. The removable electrode in this invention can be easily removed and replaced because it is not fixed to the body of the capillary-holding device in any way.

Referring to FIG. 3, a piece of insulator 10 is used in this invention to electrically insulate the capillary-holding device 2 to prevent a short circuit, which can be formed by the micromanipulators connected by a metal base plate. The insulator 10 is made of non-conductive material. In one embodiment, the insulator 10 is a tube made of durable plastic such as PVC plastic. It is 5 cm long, 4 mm of inside diameter and 5 mm of outside diameter. PVC plastic tube of the suitable size is available from companies well known to those skilled in the art. The insulator 10 is placed outside the capillary-holding device 2 to provide a non-conductive barrier between the capillary-holding device and the micromanipulator. In another embodiment, the insulator can be a piece of non-conductive material lined on the surface of the holding arm of the micromanipulator.

The fabrication of microinjection tools, such as holding capillary and injection capillary, and the setup of the microinjection system can be conducted according to standard procedures well known to those skilled in the art. The holding and injection capillaries are preferably made from silica glass micro capillaries, which are commercially available from various companies known to those skilled in the art. Some suitable capillaries are borosilicate glass capillary from Sutter Instrument Company of California. The capillary-holding device is outfitted with a piece of insulator before being placed onto the micromanipulator. Care should be taken to make sure there is no direct contact between the metal parts of the capillary-holding device and the micromanipulator. A removable electrode is then inserted into the capillary-holding device. The injection capillary is back-filled with DNA solution before being attached to the capillary-holding device. The solution inside the injection capillary should be enough to make contact with the removable electrode. Likewise, the holding capillary is back-filled with embryo medium (for example, M2 medium) before being attached to the other capillary-holding device. The embryo medium inside the holding capillary should also be enough to make contact with the other removable electrode. The capillary-holding devices are then connected to the electric power supply through the output cables. Care should be taken to make sure that the injection capillary is connected to the anode, and the holding capillary to the cathode of the power supply.

Microinjection is conducted according to the standard procedure known to those skilled in the art except the usage of electroosmosis. An egg is grabbed and held by the holding capillary. The injection capillary is brought into close proximity to the egg. The injection capillary is then inserted into the egg by manipulating the micromanipulators. Once the injection capillary is positioned inside the egg, electric current is delivered to the injection capillary to produce an electroosmotic force to propel the flow of fluid out of the injection capillary. In one embodiment, the electric current is a DC ranging from 1 to 30V. The higher the voltage is, the stronger the fluid flow is. But usually 12V DC is enough. The duration of the electric current can range from 0.001 to 1 second. Usually duration of 0.01 seconds is long enough to deliver enough DNA solution into the egg. Once enough DNA solution is injected into the egg, the electric current is switched off and the injection capillary is then withdrawn. This process is repeated on other eggs. Upon the completion of the injection, the eggs are washed and returned into an incubator or transferred into a host animal for further development.

The invention distinguishes itself from a hydraulic microinjection by utilizing an electroosmotic force to propel the flow of fluid inside the injection capillary during microinjection. In a hydraulic microinjection device the hydraulic pressure is used to propel the fluid flow. The present invention differs from the localized electro-permeabilization method in that the later uses the electric field only to induce permeabilization of the cell membrane. But in this invention the cell membrane is penetrated mechanically by the injection capillary and the electric current is used to propel the flow of fluid into the cells then. Furthermore, the localized electro-permeabilization method is only suitable for naked cells of small sizes. It is not suitable for eggs, which are usually 50 to 200.mu.m in diameter and are usually surrounded by a thick protein coat.

I claim:

1. A method for injecting materials into a cell or an intracellular structure, comprising:
penetrating the cell membrane of the cell with a liquid-filled capillary; and
applying electric current to the said capillary to propel the flow of the liquid inside the said capillary into the cell by electroosmosis.

2. A method according to claim 1, further comprising the step of penetrating the membrane of the intracellular structure before applying electric current to the said capillary to propel the flow of the liquid inside the said capillary into the intracellular structure by electroosmosis.

3. A method according to claim 1, wherein the electric current is a direct current.

4. A method according to claim 1, wherein the capillary is a silica glass capillary.

5. A method according to claim 1, wherein the capillary is positioned by the use of a 3-dimensionally positioning device.

6. A method according to claim 1, wherein the cell is an egg.

7. A method according to claim 2, wherein the liquid contains at least DNA.

8. A method according to claim 2, wherein the intracellular structure is a nucleus of an egg.

9. A method according to claim 2, wherein the capillary is a silica glass capillary.

10. A method according to claim 2, wherein the capillary is positioned by the use of a 3-dimensionally positioning device.

11. A device for injecting materials into a cell or an intracellular structure, comprising:
an electric power supply; and
a liquid-filled capillary operatively connected to the said electric power supply;
wherein the cell membrane of the cell is mechanically penetrated by the said capillary and electric current is delivered to the said capillary to propel the flow of liquid inside the said capillary into the cell or the intracellular structure by electroosmosis.

12. A device according to claim 11, wherein the membrane of the intracellular structure is mechanically penetrated by the said capillary before the electric current is delivered to the said capillary to propel the flow of liquid inside the said capillary into the intracellular structure by electroosmosis.

13. A device according to claim 11, wherein the current from the electric power supply is a direct current.

14. A device according to claim 11, further comprising a foot switch to control the output of the electric current.

15. A device according to claim 11, further comprising a timing device to control the duration of the output of the electric current.

16. A device according to claim 11, further comprising a micro-syringe connecting to the said capillary to regulate the hydraulic pressure inside the said capillary.

17. A device according to claim 11, further comprising a piece of non-conductive material being placed outside capillary-holding device to electrically insulate the capillary-holding device.

18. An electrode for transmitting electric current from capillary-holding device to liquid inside capillary, comprising an electrode being placed inside the capillary and the capillary-holding device wherein the said electrode is physically independent of the capillary-holding device.

19. An electrode according to claim 18, wherein the electrode has one or more curved shapes.

20. An electrode according to claim 18, wherein the electrode is a metal wire of 20 cm or less in length and 10 AWG or smaller in diameter.
